(19) United States
(12) Patent Application Publication
(10) Pub. No.: US 2016/0245680 A1
(43) Pub. Date: Aug. 25, 2016

(54) Method for Measuring the Flow Rate of a Liquid Medium and Device for Implementing Same

(71) Applicant: Vasily R. RASSOMAGIN, Perm (RU)

(72) Inventor: Vasily R. RASSOMAGIN, Perm (RU)

(21) Appl. No.: 15/090,193

(22) Filed: Apr. 4, 2016

Related U.S. Application Data
(63) Continuation of application No. PCT/RU2014/000006, filed on Jan. 10, 2014.

(30) Foreign Application Priority Data
Oct. 8, 2013 (RU) 2013145142

(51) Int. Cl. G01F 1/60

(52) U.S. Cl. CPC G01F 1/60

(57) ABSTRACT

The device for measuring the flow rate of a liquid medium comprises a pipeline of dielectric material, permanent magnets arranged on different sides of the pipeline, an oscillatory circuit consisting of an inductance coil and a capacitor, the plates of said capacitor being arranged on both sides of the pipeline, and a measuring system. Resonant oscillations of an electromagnetic field are excited in the oscillatory circuit. A liquid medium moving in a constant magnetic field is polarized under the Lorentz forces. As a result, the electrical field of the capacitor of the oscillatory circuit, the dielectric strength of the liquid medium and the length of the first and second half-periods of the resonant oscillations of the electromagnetic field are changed. The flow rate of the liquid medium is determined by the change in the length of the first or second half-periods of the resonant oscillations of the electromagnetic field.

### RELATED APPLICATIONS

This Application is a Continuation application of International Application PCT/RU2014/000006, filed on Jan. 10, 2014, which in turn claims priority to Russian Patent Applications No. 2013145142, filed Oct. 8, 2013, both of which are incorporated herein by reference in their entirety.

### FIELD OF THE INVENTION

The invention relates to the field of measurement technology and can be used for measuring the flow rate of water, gasoline, diesel fuel, and kerosene.

### BACKGROUND OF THE INVENTION

A method is known for determining the flow rate of fuel (see specification for USSR Inventor's Certificate No.1835490 A1, IPC G 01 F 1/66)—an analog of the proposed method of measuring the flow rate of a liquid medium, wherein the flow rate of the fuel from the supradiaphragmal chamber of the pump into the pressure line made of a dielectric material is estimated from the extreme positions of the repetitive movement of the fuel pump diaphragm.

In this case the pressure line is preliminarily filled with fuel containing a minimum amount of gaseous inclusions, electromagnetic oscillations are excited in the pressure line, and the reference value of the resonance frequency is recorded, electromagnetic oscillations are excited in the subdiaphragm chamber of the fuel pump and in the pressure line upon repetitive movement of the diaphragm, the maximum difference of the values of the resonance frequency for one cycle of the movement of the diaphragm, and the value of the current resonance frequency in the pressure line are measured, the difference between the reference and current values of the resonance frequencies in the pressure line is determined, and the flow rate of the fuel is determined by the product of these differences.

In said analog method, the flow rate of the fuel is determined by the aforesaid product of the differences of the resonance frequencies.

Mechanical wear and fatigue of the materials of the moving parts of the fuel pump occur during the repetitive movement of the diaphragm, which reduces the accuracy of the measurement method for determining the flow rate of the fuel.

A method for determining the flow rate of a liquid in a pipeline is the closest analog—the prototype of the proposed method of measuring the flow rate of a liquid medium (see specification of Russian Federation patent No. 2190833 C2, IPC G 01 F 1/58).

In said method for determining the flow rate of a liquid in a pipeline, the magnetic field strength associated with the electrical charge of liquid is derived at any point on the perimeter of the measurement section of the pipeline and is converted by means of a current transformer encircling the pipeline into an electrical signal proportional to the flow rate.

In this case, the measurement section of the pipeline is made of a polymeric material with high triboelectric capacity and variable internal cross-section, having the form of sequentially connected narrowing and expanding cones, and is equipped with a metal ground, thereby providing a high degree of polarization of the moving liquid.

In the method of determining the flow rate of a liquid in a pipeline, the flow rate of the liquid medium is measured based on the variation in the magnetic field strength associated with the electrical charge of liquid at any point on the perimeter of the measurement section of the pipeline. In the process, the magnetic field strength is converted by means of a current transformer encircling the pipeline into an electrical signal proportional to the flow rate.

In the prototype method the measurement section of the pipeline is made of a polymeric material that has low wear resistance (abrasion resistance).

As a result of this, with friction of the moving liquid against the wall of the pipeline, mechanical wear of the measurement section of the pipeline, reduction of the degree of triboelectric charging, and a decrease in the charge of the flowing liquid occur, reducing the sensitivity and accuracy of measurement.

A polarization flowmeter is known (see specification for USSR Inventor's Certificate No. 1553831 A1, IPC G 01 F 1/56)—an analog of a proposed device for measuring the flow rate of a liquid medium, implementing the technical embodiment of the proposed method.

Said polarization flowmeter consists of a dielectric body, cover, input and output channels, a flow section, a working electrode, a measuring electrode, a working electrode, and a measuring device and pins, wherein the measuring device is connected between the measuring electrode and the common bus by means of a pin, the working electrode is connected to the common bus by means of a pin, and the working electrode is connected to the power source by means of a pin.

The polarization flowmeter operates in the following manner.

A dielectric liquid enters the flow meter through the inlet channel into the flow section. High voltage is applied from the power source to the two working electrodes. An electric field is created in the liquid, under the action of the forces of which dielectric polarization of the liquid occurs.

The density of bound charges formed in the liquid is proportional to the voltage of the power supply and the flow rate. Thus, the signal of the measuring device is proportional to the number of charges carried away by the flow and, assuming constant voltage from the power source, is directly proportional to the flow rate of the liquid.

The flow rate of the liquid is measured in the polarization flowmeter based on the variation in the density of bound charges generated in the liquid when it is polarized by an electric field.

A high voltage power supply is required for the polarization of the liquid. Consequently, the polarization flowmeter can not measure the flow rate of flammable liquids such as gasoline, diesel fuel, or kerosene, which narrows the field of use of the polarization flowmeter. The electrical safety of the polarization meter is decreased thereby.

A liquid and a gas flowmeter, the prototype of a proposed device for measuring the flow rate of a liquid medium, implementing the technical embodiment of the proposed method, is the closest analog (see specification for USSR Inventor's Certificate No. 1296845 A1, IPC G 01 F 1/56).

The liquid and gas flowmeter comprises a housing with a channel formed of a nonmagnetic material such as fiberglass. An elastic plate made of ferromagnetic material, the free end of which is provided with a permanent magnet, is cantileveredly fitted on the inner channel wall of the housing. An electromagnet is mounted on the housing made in the form of a section of the pipeline in such a way that the elastic plate is in its magnetic field. A controlled sawtooth voltage generator powers the electromagnet coil via the switching block. The generator control circuit includes a power unit, connected via a magnetically controlled contact to the trigger input.

The magnetically controlled contact is mounted on the housing of the flowmeter in such a way that the axis passing through its contacts is parallel to the axis of the housing. The magnetically controlled contact is protected from the action of the electromagnet field by a shield. A permanent magnet is placed on the plate parallel to the axis of the magnetically controlled contact and its north pole is directed toward the channel inlet. The trigger input is connected by means of the magnetically controlled contact to the power unit. The trigger is used to form a rectangular voltage pulse and to exclude redundant actuations of the control circuit during contact “chatter” of the element. The trigger output is connected to the input of the differentiator circuit which shortens the triggering pulse. The output of the differentiator circuit is connected to the input of a single-trip multivibrator which is used to generate an amplitude- and length-normalized pulse necessary for stable control of the switching block and the sawtooth voltage generator. The single-trip multivibrator is also connected with a frequency meter.

The liquid and gas flowmeter operates in the following manner

In its initial state, when flow movement is absent, the sawtooth voltage generator produces sawtooth-pattern voltage feeding the electromagnet coil. The current in the coil increases to a maximum value, and then drops abruptly to zero. This variation in current is necessary for the plate with the permanent magnet to smoothly deviate from its initial position to the zone of actuation of the element and return to the original position by its own elastic forces when the current in the coil drops to zero. Due to the effect of the electromagnetic field, the plate with the permanent magnet moves toward the element; at the same time, the permanent magnet moves incrementally perpendicular to the axis of the element and intersects only a single zone of the breaker contact of the element. When the magnet reaches the zone of actuation, the contact of the elements close, the voltage from the block is presented to the input of the trigger which forms a rectangular pulse. Since the single-trip multivibrator remains connected to the triggering circuit during the process of actuation, the triggering pulses of the differentiator circuit are shortened in order to attenuate the effect of the triggering circuit on its actuation. Further, a pulse is presented to the single-trip multivibrator connected to the frequency meter. The single-trip multivibrator generates a rectangular pulse, the duration of which is sufficient for the plate to return to the initial state. The pulse generated by the single-trip multivibrator is presented simultaneously to the input of the sawtooth voltage generator, the frequency meter, and the switching block. In the process, opening of the switching block occurs for a time equal to the duration of the pulse, as a result of which the circuit of the electromagnet coil opens. The plate with the permanent magnet fitted thereon returns under the influence of elastic forces to the initial state. The pulse acts on the operation of the generator in such a way that the following increase in voltage at the output of the generator occurs after a time equal to the duration of the pulse of the single-trip multivibrator.

In the presence of a flow of liquid or gas, the plate with the permanent magnet reaches the maximum deviation over a longer period of time due to the increased resistance of the moving medium. The actuation of the element occurs at a later point in comparison with the original, as the frequency of actuation of the magnetically controlled contact varies, just as the corresponding occurrence frequency of the rectangular pulses generated by the trigger. This varies the frequency of the pulses of the single-trip multivibrator, which controls the operation of the switching block and the generator. The frequency of the oscillations of the generator output voltage varies and causes a corresponding variation in the frequency of voltage in the coil.

Under the influence of the field of the electromagnet, the frequency of oscillations of the plate varies. Thus, depending on variations in the liquid or gas flow rate, the frequency of oscillations of the plate with the magnet varies. The varied signal is presented to the generator control circuit and is displayed by the frequency flowmeter.

In the liquid and gas flowmeter, measurement of the flow rate of the liquid or gas occurs due to the variation in the frequency of oscillations of the elastic plate with magnet; this frequency is displayed by the frequency flowmeter.

With a large number of oscillations of the elastic plate with magnet, a change occurs in the elastic properties of the plate, which reduces the accuracy of the measurement of the flow rate of a liquid or gas.

The elastic plate with magnet is mounted in the flow section of the liquid and gas flowmeter, which reduces the measurement accuracy and manufacturability.

### SUMMARY OF THE INVENTION

The objective of this invention is to develop a method for measuring the flow rate of a liquid medium, which extends the arsenal of technical means for measuring the flow rate of the liquid medium and increases the accuracy of measurement, as well as the creation of a device for measuring the flow rate of a liquid medium that implements the technical embodiment of the proposed method, a device which has greater measurement accuracy and manufacturability.

The stated objective is achieved by the features specified in claim 1 that are common to the prototype method, such as a method for measuring the flow rate of the liquid medium, consisting in the fact that a liquid medium is placed, moved, and polarized within a pipeline made of a dielectric material, and having distinctive essential features, such as resonance oscillations of the electromagnetic field being excited in an oscillatory circuit which comprises an inductance coil and a capacitor of the oscillatory circuit;, the liquid medium being moved in a magnetic field, the liquid medium being polarized by the Lorentz force, thereby varying the electric field of the capacitor of the oscillatory circuit in the liquid medium, the dielectric constant of the liquid medium, as well as the duration of the first and second half-periods of the period of the resonant oscillations of the electromagnetic field of the oscillatory circuit, and the flow rate of the liquid medium being measured based on the variation in the duration of the first or second half-cycles of the period of the resonant oscillations of the electromagnetic field of the oscillatory circuit.

A feature of the movement of the liquid in the pipeline has been reflected in claim 2, namely, the liquid medium is moved in a constant magnetic field.

A feature of the embodiment of the pipeline has been reflected in claim 3, namely, the pipeline is made of a ceramic material which has high abrasion resistance.

In the proposed method, when the liquid medium is moved in a constant magnetic field, polarization of the liquid medium takes place by the Lorentz force.

As a result of this, the electric field of the capacitor of the oscillatory circuit in the liquid medium, the dielectric constant of the liquid medium, as well as the duration of the first and second half-cycles period of the resonant oscillations of the electromagnetic field of the oscillatory circuit vary.

Therewith the flow rate of the liquid medium is measured based on the variation in the duration of the first or second half-cycle of the period of the resonant oscillations of the electromagnetic field of the oscillatory circuit, which expands the arsenal of technical means for measuring the flow rate of the liquid medium.

The pipeline of the proposed method for measuring the flow rate of a liquid medium is preferentially made of a ceramic material which has high abrasion resistance.

As a consequence of this, the mechanical wear of the pipeline through the movement of the liquid medium is reduced, which increases the accuracy of measurement.

The stated objective is achieved by means of the features specified in the 4th claim that are common to the prototype device, such as a device for measuring the flow rate of a liquid medium, comprising a liquid medium placed in a pipeline, a magnet, and an inductance coil, and distinctive essential features, such as the fact that the device comprises an oscillatory circuit that comprises an inductance coil of the oscillatory circuit and a capacitor of the oscillatory circuit, wherein the liquid medium is placed in the pipeline between the pole terminals of the magnet, as well as between the first and second plates of the capacitor of the oscillatory circuit.

A feature of the movement of the liquid medium in the pipeline has been reflected in claim 5, namely, the liquid medium is placed in the pipeline between the pole terminals of a permanent magnet.

The flow section of the pipeline is free of elements comprising the proposed device for measuring the flow rate of a liquid medium, which increases the accuracy of measurement and manufacturability.

In the proposed device, the liquid medium is polarized by the Lorentz force, which is induced in the liquid medium as the liquid medium is moved in a constant magnetic field of the permanent magnet. As a result, polarization of the liquid medium does not require a power source which increases manufacturability of the device implementing the technical embodiment of the proposed method.

The aggregate of the essential features enumerated above makes possible the following technical result—the expansion of the arsenal of technical means for measuring the flow rate of a liquid medium, increased accuracy of measurement and manufacturability.

### BRIEF DESCRIPTION OF THE DRAWINGS

FIG. 1 depicts a block diagram of the device for measuring the flow rate of a liquid medium.

### DETAILED DESCRIPTION OF THE PREFERRED EMBODIMENTS

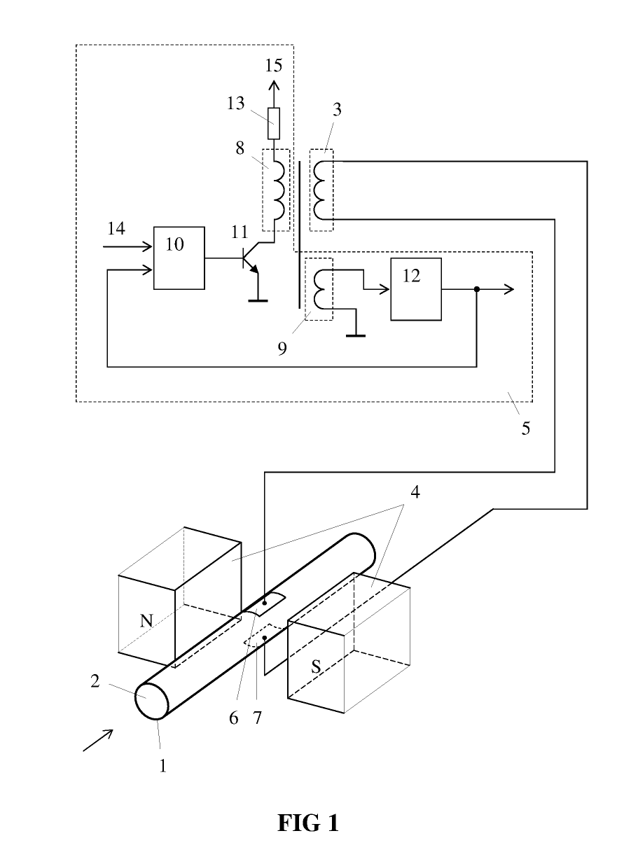

The proposed device for measuring the flow rate of a liquid medium comprises a liquid medium 2 placed inside the pipeline 1 made of a dielectric material (see FIG. 1), a permanent magnet 4, an oscillatory circuit, and a measurement circuit 5.

A dielectric liquid, such as gasoline, diesel fuel, kerosene, or poorly conducting (or weakly conducting) liquid medium, such as tap water, can fulfill the function of the liquid medium 2.

The pipeline 1 is preferentially made of a ceramic material which has high abrasion resistance.

The pipeline 1 has an internal cross-section in the form of a circle. In the general case, pipeline 1 may have an internal cross-section in the form of a rectangle.

The pole terminals (north N and south S poles) of permanent magnet 4 are depicted in FIG. 1.

The oscillatory circuit comprises an inductance coil 3 of the oscillatory circuit and a capacitor of the oscillatory circuit; the liquid medium 2 is placed in pipeline 1 between the pole terminals of permanent magnet 4, as well as between the first 6 and second 7 plates of the capacitor of the oscillatory circuit.

At the same time, a straight line passing through the centers of the first 6 and second 7 plates of the capacitor of the oscillatory circuit and the axis of pipeline 1, is perpendicular to the straight line passing through the centers of the pole terminals of permanent magnet 4 and the axis of the pipeline 1.

The first 6 and second 7 plates of the capacitor of the oscillatory circuit are placed on the outer surface of pipeline 1. In the general case, the first 6 and second 7 plates of the capacitor of the oscillatory circuit can be placed on the inner surface of the pipeline 1.

The first terminal of inductance coil 3 of the oscillatory circuit is connected to first 6 plate of the capacitor of the oscillatory circuit, and the second terminal of inductance coil 3 of the oscillatory circuit is connected to second 7 plate of the capacitor of the oscillatory circuit.

Measurement circuit 5 comprises inductance coil 8 pumping energy into the oscillatory circuit, an inductance coil 9 for readout of the frequency of resonant oscillations of the oscillatory circuit, OR element 10, transistor 11, comparator 12, resistor 13, and a computing device (not shown).

The second input terminal 14 of OR element 10 is the input to trigger continuous undamped resonant oscillations of the electromagnetic field of the oscillatory circuit. The output terminal of OR element 10 is connected to the base of transistor 11, the emitter of which is connected to the “Common” terminal of the power source.

The first and second output terminals of inductance coil 8 for pumping energy into the oscillatory circuit are connected respectively to transistor collector 11 and the first output terminal of resistor 13, the second output terminal of which is connected to positive output terminal 15 of the power source of measurement circuit 5.

The first and second output terminals of inductance coil 9 for readout of the frequency of resonant oscillations of the oscillatory circuit are connected respectively to the “Common” terminal of the power supply and the direct input terminal of comparator 12, to the inverting input of which a reference voltage is fed. The comparator 12 output terminal is connected to the first input terminal of OR element 10 and the computing device.

Inductance coil 3 of the oscillatory circuit has minimal intrinsic capacitance and maximum inductance, which increases the sensitivity of the device for measuring the flow rate of a liquid medium.

Inductance coil 8 for pumping energy into the oscillatory circuit and inductance coil 9 for readout of the frequency of resonant oscillations of the oscillatory circuit are made by winding insulated wire over inductance coil 3 of the oscillatory circuit.

The direction of flow of liquid medium 2 is designated in the figure by an arrow.

The device for measuring the flow rate of a liquid medium, implementing the technical embodiment of the proposed method works as follows.

A liquid medium 2 is placed inside pipeline 1 made of a dielectric material.

After power is turned on, a single positive pulse is fed into second input terminal 14 of the OR element 10 from the parallel channel of measurement circuit 5. A positive pulse from output terminal of OR element 10 is presented to the base of transistor 11 and opens it.

At times of variation of the currents in inductance coil 8 for pumping energy into the oscillatory circuit, EMFs—electromotive induction forces are induced in inductance coil 3 of the oscillatory circuit and resonant oscillations of the electromagnetic field are excited in the oscillatory circuit.

The frequency of the resonant oscillations of the electromagnetic field of the oscillatory circuit is read off inductance coil 9 for readout of the frequency of resonant oscillations of the oscillatory circuit and presented to the input terminal of comparator 12. The positive rectangular signals from the output terminal of comparator 12 are presented to the computing device of measurement circuit 5 and to the first input terminal of OR element 10.

Rectangular pulses from the output terminal of OR element 10 are presented to the base of transistor 11, upon the opening of which currents flow through the inductance coil 8 for pumping energy into the oscillatory circuit, in the event of variation of which an induction EMF is induced in inductance coil 3 of the oscillatory circuit.

Thereat, in the first (or positive) half-periods of the oscillations of the electromagnetic field of the oscillatory circuit, pumping of energy into the oscillatory circuit occurs during increase in the current in inductance coil 8 pumping energy into the oscillatory circuit, whereas in the second (or negative) half-periods of the oscillations of the oscillatory circuit, pumping of energy occurs during decrease in the current.

Since the transfer of energy into the oscillatory circuit occurs at times of variation in currents in the inductance coil 8 pumping energy into the oscillatory circuit (under the influence of induction EMF, currents are induced that coincide with the direction of the currents in the resonant circuit). In the process, the amplitudes of the currents of the resonant oscillations of the electromagnetic field of the oscillatory circuit increase and determine the frequency of resonance oscillations of the electromagnetic field of the oscillatory circuit.

Thus, resonance vibrations of the electromagnetic field are excited in the oscillatory circuit, which comprises induction coil 3 and a capacitor of the oscillatory circuit.

In the first half-period of resonance oscillations of the electromagnetic field of the oscillatory circuit, the electric field vector of the capacitor of the oscillatory circuit is directed from the first 6 to the second 7 plate of the capacitor of the oscillatory circuit (downwards).

In the second half-period of resonance oscillations of the electromagnetic field oscillatory circuit, the electric field vector of the oscillatory circuit is directed from the second 7 to the first 6 plate of the capacitor of the oscillatory circuit.

Liquid medium 2 is moved in the constant magnetic field of permanent magnet 4 and liquid medium 2 is polarized by the Lorentz force.

Consequently, the electric field of the capacitor of the oscillatory circuit (external electric field) in liquid medium 2, the dielectric constant of liquid medium 2, as well as the duration of the first and second half-periods of the period of the resonance oscillations of the electromagnetic field of the oscillatory circuit are varied, and the flow rate of liquid medium 2 is measured based on the variation in the duration of the first and second half-periods of the period of the resonance oscillations of the electromagnetic field of the oscillatory circuit.

During the first half-period of the period of the resonant oscillations of the electromagnetic field of the oscillatory circuit, the direction of the Lorentz force and the direction of the electric field vector of the capacitor of the oscillatory circuit coincide.

During the second half-period of the period of the resonant oscillations of the electromagnetic field of the oscillatory circuit, the direction of the Lorentz force is opposite to the direction of the electric field vector of the capacitor of the oscillatory circuit.

When the flow rate of liquid 2 increases, the Lorentz force in liquid medium 2 increases, whereas when the flow rate of the liquid 2 decreases, the Lorentz force in liquid medium 2 decreases.

The polarization of liquid medium 2 may occur due to the polarization of molecules, positively charged ions, and negatively charged ions.

With polarization of molecules of liquid medium 2, an excess develops of bound charges of the same sign and a change in the surface density of the bound charges takes place in the thin surface layer of liquid 2.

Upon polarization of the positively charged ions and negatively charged ions of liquid medium 2, movement and separation of the positively charged ions and negatively charged ions of liquid medium 2 take place in the direction and opposite the direction of the Lorentz force in liquid medium 2.

This results in a change in the density of the positively charged ions and negatively charged ions of liquid medium 2.

With an increase in the flow rate of liquid medium 2 during the first half-period of the period of the resonant oscillations of the electromagnetic field of the oscillatory circuit, a reduction (weakening) of the electric field of the capacitor of the oscillatory circuit in liquid medium 2 and an increase in the dielectric constant of liquid medium 2 and in the duration of the first half-period of the period of the resonant oscillations of the electromagnetic field of the oscillatory circuit take place.

Thereat, in the general case, the resulting (total) electric field of the bound charges of molecules of liquid medium 2 and of the positively charged ions and negatively charged ions is directed opposite to the direction of the electric field vector of the capacitor of the oscillatory circuit in liquid medium 2.

With a decrease in the flow rate of liquid medium 2 during the first half-period of the period of the resonant oscillations of the electromagnetic field of the oscillatory circuit, an increase (intensification) of the electric field of the capacitor of the oscillatory circuit in liquid medium 2 and a decrease in the dielectric constant of liquid medium 2 and in the duration of the first half-period of the period of the resonant oscillations of the electromagnetic field of the oscillatory circuit take place.

With an increase in the flow rate of liquid medium 2 during the second half-period of the period of the resonant oscillations of the electromagnetic field of the oscillatory circuit, an increase (intensification) of the electric field of the capacitor of the oscillatory circuit in liquid medium 2 and a decrease in the dielectric constant of liquid medium 2 and in the duration of the second half-period of the period of the resonant oscillations of the electromagnetic field of the oscillatory circuit take place.

With a decrease in the flow rate of liquid medium 2 during the second half-period of the period of the resonant oscillations of the electromagnetic field of the oscillatory circuit, a reduction (weakening) of the electric field of the capacitor of the oscillatory circuit in liquid medium 2 and an increase in the dielectric constant of liquid medium 2 and in the duration of the second half-period of the period of the resonant oscillations of the electromagnetic field of the oscillatory circuit take place.

Consequently, the durations of the first and second half-periods of the period of the resonant oscillations of the electromagnetic field of the oscillatory circuit will diff from one another.

### INDUSTRIAL APPLICABILITY

The proposed methods for measuring the flow rate of a liquid medium and a device for its embodiment will find wide application in measurement technology devices, and other special cases of automation of the measurement of the flow rate of a liquid medium will be evident to those skilled in the art.

This specification and examples are considered as material illustrating the invention, the essence of which and scope of the patent claims are defined in the following claim by the aggregate of essential features and their equivalents.

1. A method for measuring a flow rate of the liquid medium, the method compirsing: placing a liquid medium, within a pipeline of a dielectric material;
exciting resonance oscillations of an electromagnetic field in an oscillatory circuit which comprises an inductance coil and a capacitor of the oscillatory circuit;
moving the liquid medium in a magnetic field;
polarizing the liquid medium by a Lorentz force, thereby varying an electric field of the capacitor of the oscillatory circuit in the liquid medium, the dielectric constant of the liquid medium, and a duration of a first half-period and a second half-period of a period of resonant oscillations of the electromagnetic field of the oscillatory circuit; and
measuring the flow rate of the liquid medium based on a variation in the duration of the first half-period or the second half-period periods of the period of the resonant oscillations of the electromagnetic field of the oscillatory circuit.

2. The method according to claim 1, wherein moving the liquid medium occurs in a constant magnetic field.

3. The method according to claim 1, further comprising making the pipeline of a ceramic material with high abrasion resistance.

4. A device for measuring the flow rate of a liquid medium comprising:
the liquid medium placed in a pipeline, a magnet, and an inductance coil, wherein the device comprises an oscillatory circuit that comprises the inductance coil of the oscillatory circuit and a capacitor of the oscillatory circuit, and wherein the liquid medium is placed in the pipeline between pole terminals of the magnet and between a first and a second plates of the capacitor of the oscillatory circuit.

5. The device according to claim 4, the liquid medium is placed in the pipeline between the pole terminals of the magnet which is a permanent magnet.
